(19) United States
(12) Patent Application Publication
(10) Pub. No.: US 2015/0291155 A1
(43) Pub. Date: Oct. 15, 2015

(54) DEVICE AND METHOD FOR THE IMPROVEMENT OF SAFETY WHEN DRIVING A VEHICLE

(71) Applicant: SCANIA CV AB, Södertälje (SE)

(72) Inventors: Håkan JONSSON, Hägersten (SE); Martin EDINGER, Södertälje (SE); Tomas ÖSTLUND, Huddinge (SE)

(21) Appl. No.: 14/646,810

(22) PCT Filed: Dec. 3, 2013
(86) PCT No.: PCT/SE2013/051431

§ 371 Date: May 22, 2015

(30) Foreign Application Priority Data
Dec. 4, 2012 (SE) 1251372-7
Dec. 2, 2013 (SE) 1351426-0

(51) Int. Cl. B60W 30/02; B60R 16/023; B60T 7/12

(52) U.S. Cl. CPC B60W 30/02; B60T 7/12; B60R 16/023; B60W 2520/14; B60W 2520/26

(57) ABSTRACT

A method for improvement of safety when driving a vehicle includes the steps to: continuously (s410) establish a measure of instability relating to the vehicle; continuously provide (s420) the measure of instability within a communications network internal to the vehicle (L230, L240), to which network at least one vehicle braking function's control device (240a; 240b; 240c; 240d) is connected; and continuously establish the measure of instability based on a difference between an expected propulsion and an actual propulsion. Also, a computer program product with program code (P) for a computer (200; 210) to implement the method. Also, a device (298, 299) for improving safety when driving a vehicle and a motor vehicle (100) equipped with such a device.

### CROSS-REFERENCE TO RELATED APPLICATIONS

The present application is a 35 U.S.C. §§371 national phase conversion of PCT/SE2013/051431, filed Dec. 3, 2013, which claims priority of Swedish Patent Application No. 1251372-7, filed Dec. 4, 2012, the contents of which are incorporated by reference herein and Swedish Patent Application No. 1351426-0, filed Dec. 2, 2013, the contents of which are incorporated by reference herein. The PCT International Application was published in the English language.

### TECHNICAL FIELD

The present invention pertains to a method for the improvement of safety when driving a vehicle. The invention also relates to a computer program product, comprising program code for a computer, to implement a method according to the invention. The invention also pertains to a device for the improvement of safety when driving a vehicle, and a vehicle which is equipped with such a device.

### BACKGROUND

In the context of increasing performance requirements in relation to newly manufactured motor vehicles, and as motor vehicles are used in ever tougher operating and ambient conditions, various stability systems have been developed and implemented, and it is extremely important for vehicle manufacturers to offer safer motor vehicles in order to minimise the risk of accidents or incidents while driving motor vehicles, for example heavy goods vehicles, not least having regard to the increasingly tough competition among different vehicle manufacturers. It should be pointed out that vehicles which are driven during temporarily or permanently unstable conditions e.g. on public roads, off-road, or at different plants may present a danger to the vehicle operator, other road users and objects or buildings in the vehicle's vicinity. Accidents or incidents connected with operation of a vehicle during unstable conditions may entail serious consequences to both people and the environment, for example in the event of a collision or leakage of loaded goods.

Currently, motor vehicles equipped with some form of stability system, supporting an operator of the motor vehicle, are available. These stability systems may be arranged to continuously establish, during the operation of the vehicle, a stability related parameter.

U.S. Pat. No. 5,510,989 describes a system to affect a vehicle's dynamics when driving the vehicle. The system includes a number of sensors adapted to detect a number of different variables, where sensors send signals comprising the variables to an evaluation unit. The evaluation unit processes the signals and forwards them to control devices for the vehicle dynamic motion.

US 20040254703 describes a system which from detected sensor signals establishes a stability indicator. The stability indicator provides a communication network to which various vehicle management systems are connected. The stability indicator is compared to a threshold, and when the stability indicator is equal to or exceeds the threshold, the use of the vehicle management system is restricted.

US2006265108 describes a stability system for a vehicle, where one parameter related to the risk of roll over is calculated. Further, an indicator variable is calculated, which is related to the roll over tendency, and the indicator variable may be used to draw the attention of the vehicle driver to the presence of a roll over risk, for example with a lamp arranged in an instrument panel of the vehicle.

### SUMMARY OF THE INVENTION

One objective of this invention is to provide a novel and advantageous method for the improvement of safety when driving a vehicle.

Another objective of the invention is to provide a novel and advantageous device and a novel and advantageous computer program for the improvement of safety when driving a vehicle.

Yet another objective of the invention is to provide a method, a device and a computer program to achieve improved performance in a vehicle when driven.

According to one aspect of the invention, a method for the improvement of safety is provided, comprising the steps of:
continuously establish a measure of instability with respect to the vehicle;
continuously provide the measure of instability within a communications network internal to the vehicle to which network at least one vehicle braking functions' control device is connected;
continuously establish the measure of instability based on a difference between an expected propulsion and an actual propulsion.

The method may comprise the step of:
continuously establish the expected propulsion by performing a simulation based on yaw rate and lateral acceleration.

The method may comprise the step of:
continuously establish the actual propulsion by performing a calculation based on vehicle speed and steering rate.

By being based on a difference between an expected propulsion and an actual propulsion, establish a measure of instability in a carefully, robust and reliable way and the measure of vehicle instability is provided so that unnecessary and/or hazardous use of the vehicle brake functions can be avoided. In this way, a method and a system for causing the vehicle can be driven in a safe way is provided. By establishing a measure of instability based on an expected propulsion and an actual propulsion, a carefully, robust and reliable measure of the vehicle instability is provided.

According to one aspect of the invention a method for improvement of safety when driving a vehicle is provided, comprising the steps of continuously establishing a measure of instability with respect to the vehicle and of continuously providing the measure of instability within a communications network internal to the vehicle, to which network at least one vehicle braking function's control device is connected.

This method permits versatile use of an established measure of instability. At least one control device connected to the network may thus receive and use the measure of instability for at least one vehicle braking function stored therein, and the control device may send a braking request based on the measure of instability.

The method according to the invention is primarily suitable at vehicle speeds exceeding 20 km/h, for example 40 km/h or 60 km/h or even higher speeds. Thus, a method improves safety when driving a vehicle at speeds where an accident, for example a collision or driving into a ditch, may potentially cause extensive damage to people and/or vehicles and/or loaded goods.

According to one aspect of the invention, an unnecessary braking request from the control device with respect to the vehicle braking function may be avoided. With regard to the measure of instability, the control device may assess whether it is suitable to make a braking request to a vehicle braking function stored therein.

The method may comprise the step of:
with the control device, when required, assess whether or not the vehicle braking function should be used based on the measure of instability provided. Thus, a method is provided where use of a vehicle brake function connected with excessive risk may be avoided. Further, reduction of the number of requests regarding braking function from the at least one control device may be achieved, since this will only request a braking action in conditions which actually permit the application of a braking action.

The method may comprise the step of:
with the control device, when required, assess whether or not the vehicle braking function should be used, or alternatively changed, based on the measure of instability provided.

The method may comprise the step of:
with the control device, adjust the use of the vehicle braking function based on need, as well as on the measure of instability.

Thus an advantageous method is provided, wherein the at least one vehicle braking function control device, in certain driving conditions of the vehicle, which conditions comprise a certain measure of instability, may request less braking action than in driving conditions comprising a smaller measure of instability. Thus, a vehicle braking function may be used to a limited extent, instead of not being used at all, which may be advantageous from for example a safety perspective.

The method may comprise the step of:
based on the measure of instability, prioritise the use of at least one vehicle braking function of a number of available vehicle braking functions and/or change the distribution of braking action among different vehicle braking functions. Thus a method is provided advantageously, where the vehicle braking functions which are the most safety critical may be prioritised. The method may comprise the step of continuously establishing which vehicle functions of all the vehicle functions are active and/or the most important. Thus it is possible to efficiently prioritise which vehicle braking functions may have a braking action allocated for application of a braking action in suitable braking configurations of the vehicle, according to one aspect of the present invention. Thus it is possible to efficiently allocate braking action between different vehicle braking functions which may have a braking action allocated for application of a braking action in suitable braking configurations of the vehicle, according to one aspect of the present invention.

The vehicle braking function may comprise braking of at least one vehicle wheel and/or braking of a so-called retarder in the vehicle. The vehicle braking function may request and, where applicable, apply a braking action to a suitable set of vehicle wheels and/or to the retarder. Individual control of braking action in different braking device configurations of the vehicle is thus possible.

A vehicle communications network may comprise a CAN-bus. A vehicle specific set, comprising different control device configurations, may be connected to the CAN-bus. Thus a versatile method is provided which may be applied in many different types of vehicles. Further, according to one aspect of the invention it is possible to install, replace or remove one or several control device configurations comprising at least one vehicle braking function in the vehicle. Connection or disconnection of a control device configuration may be achieved in a simple manner by a fitter.

The method may comprise the step of:
continuously establishing the measure of instability, based on at least the parameters of lateral acceleration in the vehicle and yaw rate on the one hand, and vehicle speed and steering angle rate on the other hand. Thus an accurate and robust manner of establishing the measure of instability is achieved.

The method may comprise the step of:
continuously establishing the measure of instability S, based on at least one or a combination of the parameters of vehicle speed, lateral acceleration of the vehicle, yaw rate, steering angle, steering angle rate and wheel slip of at least one of the vehicle's wheels.

The method may comprise the step of:
continuously providing the measure of instability to a central control device, also named a controller, via the vehicle internal communications network. Thus the measure of instability may in an efficient manner be communicated further within the communications network which is internal to the vehicle. The central control device may also handle requests regarding braking action from the at least one vehicle braking function's control device.

The method is easy to implement in existing motor vehicles. Software for the improvement of safety when driving a motor vehicle according to the invention may be installed in a control device of the vehicle when it is manufactured. A purchaser of the vehicle may thus be afforded the opportunity to choose the method function as an extra option. Alternatively, software comprising program code to perform the innovative method for improvement of safety when driving a motor vehicle may be installed in a control device of the vehicle when the control device is upgraded at a service station. In this case, the software may be uploaded into a memory in the control device.

Software comprising a program code for the improvement of safety when driving a vehicle may easily be updated or replaced. In addition, different parts of the software comprising program code for the improvement of safety when driving a vehicle may be replaced independently of each other. This modular configuration is advantageous from a maintenance perspective.

According to one aspect of the invention a device is provided for the improvement of safety when driving a vehicle, comprising:
elements adapted to continuously establish a measure of instability relating to the vehicle;
elements adapted to continuously provide the measure of instability within a communications network internal to the vehicle to which at least one vehicle braking function's control device is connected;
elements adapted to continuously establish the measure of instability based on a difference between an expected propulsion and an actual propulsion.

The device may comprise:
elements adapted to continuously establish the expected propulsion by performing a simulation based on yaw rate and lateral acceleration.

The device may comprise:
elements adapted to continuously establish the actual propulsion by performing a calculation based on vehicle speed and steering rate.

According to one aspect of the invention, a device is provided for the improvement of safety when driving a vehicle, comprising:
elements adapted to continuously establish a measure of instability relating to the vehicle; and
elements adapted to continuously provide the measure of instability within a communications network internal to the vehicle, to which network at least one vehicle braking function's control device is connected.

The at least one vehicle braking function's control device may consist of several control devices, each of which may have a suitable number of vehicle braking functions stored therein. Thus an advantageous distributed solution is achieved, where the measure of instability provided within the communications network may continuously be used by a number of different control devices in the vehicle, of which each control device may use a number of different vehicle braking functions stored therein simultaneously, based on the provided measure of instability.

In the device, the control device may be adapted, where needed, to assess whether or not the vehicle braking function should be used, based on the measure of instability provided.

In the device, the control device may be adapted, where needed, to assess whether or not the vehicle braking function should be used or alternatively changed, based on the measure of instability provided.

In the device the control device may be adapted to adjust the use of the vehicle braking function to need, as well as to the measure of instability.

The device may comprise:
elements adapted to, based on the measure of instability, prioritise the use of at least one vehicle braking function of a number of available vehicle braking functions and/or change the distribution of braking action among different vehicle braking functions.

In the device, the vehicle braking function may comprise braking of at least one vehicle wheel and/or braking of a so-called retarder in the vehicle.

In the device the communications network may comprise a CAN-bus.

In the device the vehicle braking functions may be any function chosen out of the group comprising lane departure warning, differential lock management, brake control, and incident compensation management.

The device may comprise:
elements adapted to continuously establish the measure of instability based on at least the parameters of lateral acceleration in the vehicle and yaw rate on the one hand, and vehicle speed and steering angle rate on the other hand.

The device may comprise:
elements adapted to continuously establish the measure of instability S, based on at least one or a combination of the parameters of vehicle speed, lateral acceleration of the vehicle, yaw rate, steering angle, steering angle rate and wheel slip in at least one of the vehicle's wheels.

The device may comprise:
elements adapted to continuously provide the measure of instability to a central control device, also named a controller, via the vehicle internal communications network.

The above objectives are achieved also with a vehicle comprising the device for improvement of safety when driving a vehicle.

The vehicle may be a motor vehicle. The vehicle may be a hybrid vehicle.

The vehicle may be an electric vehicle.

The motor vehicle may be a truck, a bus or a car.

According to one aspect of the invention, a computer program is provided for the improvement of safety when driving a vehicle, wherein the computer program comprises program code stored in a computer-readable medium in order to cause an electronic control device or another computer, connected to the electronic control device, to perform the steps disclosed herein.

According to one aspect of the invention, a computer program is provided for the improvement of safety when driving a vehicle, wherein the computer program comprises program code stored in a computer-readable medium in order to cause an electronic control device or another computer, connected to the electronic control device, to perform the steps disclosed herein, where the program code is executed on the control device or on another computer.

According to one aspect of the invention, a computer program is provided for the improvement of safety when driving a vehicle, wherein the computer program comprises program code to cause an electronic control device or another computer, connected to the electronic control device, to perform the steps disclosed herein.

According to one aspect of the invention, a computer program is provided for the improvement of safety when driving a vehicle, wherein the computer program comprises program code to cause an electronic control device or another computer, connected to the electronic control device, to perform the steps disclosed herein, where the program code is executed on the control device or another computer.

According to one aspect of the invention, a computer program product comprising program code stored in a computer-readable medium is provided to perform the method steps disclosed herein, when the computer program is run in an electronic control device or in another computer, connected to the electronic control device.

According to one aspect of the invention, a computer program product comprising program code stored in a computer-readable medium is provided to perform the method steps disclosed herein, where the computer program is run in an electronic control device or in another computer, connected to the electronic control device.

Additional objectives, advantages and novel features of the present invention will be apparent to one skilled in the art from the following details, and through exercising the invention. While the invention is described below, it should be apparent that the invention is not limited to the specifically described details. One skilled in the art, having access to the teachings herein, will recognise additional applications, modifications and incorporations in other areas, which are within the scope of the invention.

### BRIEF DESCRIPTION OF THE DRAWINGS

For a more complete understanding of the present invention and the additional objects and advantages thereof, reference is now made to the following detailed description, which is to be read together with the accompanying drawings, in which the same reference designations pertain to identical parts in the various figures, and in which:

FIG. 1 schematically illustrates a vehicle, according to one embodiment of the invention;

FIG. 2a schematically illustrates a sub-system of the vehicle shown in FIG. 1, according to one embodiment of the invention;

FIG. 2b schematically illustrates a sub-system of the vehicle shown in FIG. 1, according to one embodiment of the invention;

FIG. 3 schematically illustrates a diagram, according to one aspect of the invention;

FIG. 4a schematically illustrates a flow diagram of a method, according to one embodiment of the invention;

FIG. 4b schematically illustrates in more detail a flow diagram of a method, according to one embodiment of the invention;

FIG. 4c schematically illustrates a flow diagram of a method according to one embodiment of the invention; and

FIG. 5 schematically illustrates a computer, according to one embodiment of the invention.

### DETAILED DESCRIPTION OF THE FIGURES

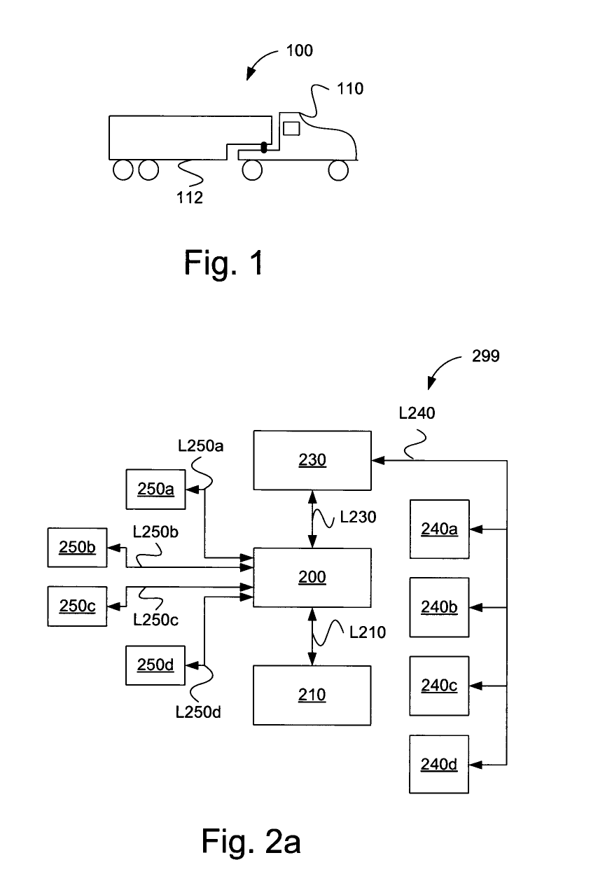

A side view of a vehicle 100 is shown with reference to FIG. 1. The exemplary vehicle 100 consists of a tractor 110 and a trailer 112. The vehicle may be a heavy goods vehicle, such as a truck or a bus. The vehicle may alternatively be a car.

The vehicle 100 may be a motor vehicle. The vehicle 100 may according to one embodiment be a hybrid powered vehicle. The vehicle 100 may according to one embodiment be an electric car.

The term “link” herein refers to a communications link, which may be a physical line such as an opto-electronic communication line or a non-physical line such as a wireless connection, for example a radio or microwave link.

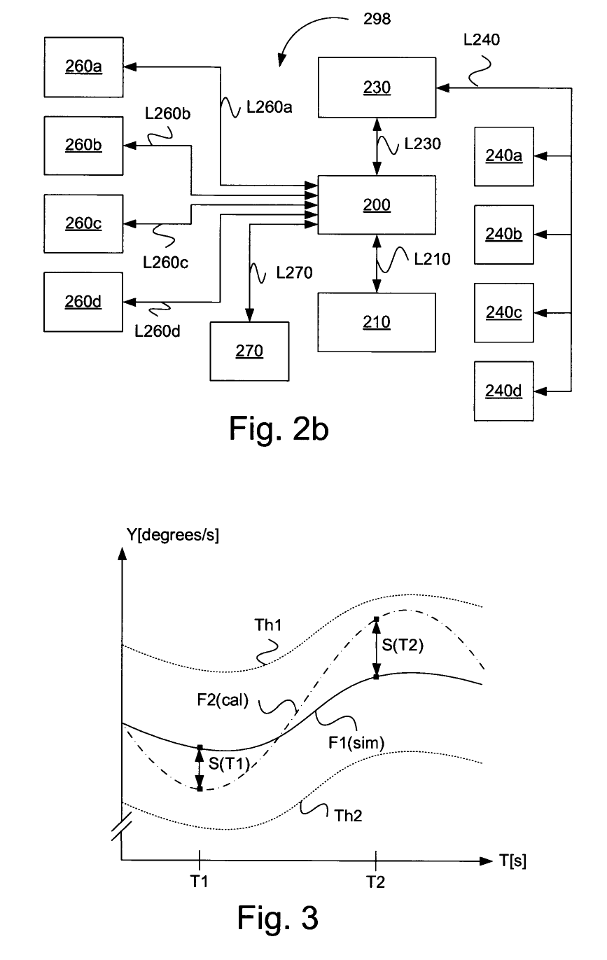

With reference to FIG. 2a, a device 299 in the vehicle 100 is shown. Sub-system 299 may be arranged in the tractor 110.

Sub-system 299 comprises a first control device 200. The first control device 200 is according to this example embodiment a braking device. The first control device 200 is arranged to control a number of different vehicle braking functions in the vehicle 100. The vehicle braking functions may, according to one embodiment, consist of brake control routines, which are stored in a memory in the first control device 200. The first control device 200 is arranged to control a number of different vehicle braking functions in the vehicle 100. The braking device configurations are described in more detail with reference to FIG. 2b.

A second control device 210 is arranged for communication with the first control device 200 via a link L210. The second control device 210 may be detachably connected to the first control device 200. The second control device 210 may be a control device external to the vehicle 100. The second control device 210 may be arranged to carry out the innovative steps of the method according to the invention. The second control device 210 may be used to transfer software to the first control device 200, in particular software to perform the innovative method. The second control device 210 may alternatively be arranged for communication with the first control device 200 via an internal communications network in the vehicle 100. The second control device 210 may be arranged to carry out essentially similar functions as the first control device 200, for example to continuously establish a measure of instability with respect to the vehicle, and to continuously provide the measure of instability within a communications network internal to the vehicle, to which network at least one vehicle braking function is connected.

The first braking device 200 is arranged for communication with a third control device 230 via a link L230. The link L230 may comprise a CAN-bus. The link L230 is comprised according to one example embodiment in a communications network internal to the vehicle. The third control device 230 is according to one embodiment a so-called controller. The third control device 230 is arranged for communication with a number of control device configurations, manoeuvring elements and sensor configurations in the vehicle 100, while only a limited number of devices are illustrated in FIG. 2a for clarity reasons. The third control device 230 is arranged to drive the vehicle according to driving routines stored in various control device configurations and control devices in the vehicle 100.

A first sensor configuration 250a is arranged for communication with the first control device 200 via a link L250a. The first sensor configuration 250a is arranged to continuously establish a prevailing lateral acceleration Alat in the vehicle 100. The first sensor configuration 250a is arranged to continuously send a signal S1 to the first control device 200 via the link L250a. The first signal S1 comprises information regarding the continuously established prevailing lateral acceleration Alat to the first control device 200. According to one example configuration, the first sensor configuration 250a is designed to be integrated with the first control device 200.

A second sensor configuration 250b is arranged for communication with the first control device 200 via a link L250b. The second sensor configuration 250b is arranged to continuously establish a prevailing yaw angle, Yaw, in the vehicle 100. The second sensor configuration 250b is arranged to continuously establish a prevailing yaw rate, Yawrate, in the vehicle 100. The second sensor configuration 250b is arranged to continuously send a signal S2 to the first control device 200 via the link L250b. The second signal S2 comprises information regarding the continuously established prevailing yaw rate, Yawrate, to the first control device 200. The second signal S2 may comprise information regarding the continuously established prevailing yaw angle, Yaw, to the first control device 200. According to one example embodiment, the second sensor configuration 250b is designed to be integrated with the first control device 200.

A third sensor configuration 250c is arranged for communication with the first control device 200 via a link L250c. The third sensor configuration 250c is arranged to continuously establish a prevailing steering angle, Steering, in the vehicle 100. The third sensor configuration 250c is arranged to continuously establish a prevailing steering rate, Steeringrate, in the vehicle 100. The third sensor configuration 250c is arranged to continuously send a signal S3 to the first control device 200 via the link L250c. The first signal S3 comprises information regarding the continuously established prevailing steering rate, Steeringrate, to the first control device 200. The third signal S3 comprises information regarding the continuously established prevailing steering angle, Steering, to the first control device 200. According to one example embodiment the third sensor configuration 250c is arranged at a steering wheel in the vehicle 100.

A fourth sensor configuration 250d is arranged for communication with the first control device 200 via a link L250d. The fourth sensor configuration 250d is arranged to continuously establish a prevailing vehicle speed V in the vehicle 100. The fourth sensor configuration 250d is arranged to continuously send a signal S4 to the first control device 200 via the link L250d. The fourth signal S4 may comprise information regarding the continuously established prevailing vehicle speed V to the first control device 200. According to one example embodiment the fourth sensor configuration 250d is arranged in at least one wheel of the vehicle 100. Alternatively, the fourth sensor configuration 250d may be arranged in a suitable place of a transmission in the vehicle 100, for example in an output shaft from the gearbox.

The first control device 200 is arranged to continuously establish a measure of instability S, based on at least the parameters of lateral acceleration Alat in the vehicle 100 and the yaw rate Yawrate on the one hand and the vehicle speed V and steering rate Steeringrate on the other hand. The measure of instability is described in more detail with reference to FIG. 3 below.

The first control device 200 is arranged to continuously establish the measure of instability based on a difference between an expected propulsion and an actual propulsion.

The first control device 200 may be arranged to continuously establish the expected propulsion by performing a simulation based on yaw rate Yawrate and lateral acceleration Alat.

The first control device 200 is arranged to continuously establish the actual propulsion by performing a calculation based on vehicle speed and steering rate.

A first control device configuration 240a is arranged for communication with the third control device 230 via a link L240. The first control device configuration 240a comprises at least one stored vehicle braking function. The first control device configuration 240a may be an engine control device. A second control device configuration 240b is arranged for communication with the third control device 230 via a link L240. The second control device configuration 240b comprises at least one stored vehicle braking function. The second control device configuration 240b may be a control device for a differential lock in the vehicle. The second control device configuration 240b may be a control device for all-wheel drive. A third control device configuration 240c is arranged for communication with the third control device 230 via a link L240. The third control device configuration 240c comprises at least one stored vehicle braking function. The third control device configuration 240c may be a control device for adaptive cruise control of the vehicle. A fourth control device configuration 240d is arranged for communication with the third control device 230 via a link L240. The fourth control device configuration 240d comprises at least one stored vehicle braking function. The fourth control device configuration 240d may be a control device for an automatic emergency brake in the vehicle.

The vehicle 100 may comprise a suitable number of control device configurations. These may be arranged for mutual communication through a suitable communications network internal to the vehicle, comprising e. g. the link L240. Each one of these control device configurations may consist of a control device existing in the vehicle.

The link L240 may constitute a part of a communications network internal to the vehicle. The link L240 may comprise a CAN-bus.

According to one aspect of the invention, the third control device 230 may be omitted, and the links L230 and L240 may consist of a communications link, which link may comprise a CAN-bus.

According to one aspect of the present invention, at least one of the control device configurations 240a-240d is adapted, where needed, to assess whether or not the vehicle braking function should be used based on the measure of instability S provided.

According to one aspect of the present invention, at least one of the control device configurations 240a-240d is adapted to adjust the use of the vehicle braking function to needs, as well as to the measure of instability S provided.

According to one aspect of the present invention, at least one of the control device configurations 240a-240d is adapted to, based on tne measure of instability S, prioritise the use of at least one vehicle braking function of a number of available vehicle braking functions. The vehicle braking function may be any one chosen out of the group comprising lane departure warning, differential lock management, brake control, and incident compensation management.

Thus a vehicle braking function relating to the function lane departure warning, based on the measure of instability S, may request and potentially obtain an allocated braking action for application in at least one braking device configuration of the vehicle. By e. g. applying the braking action to the vehicle wheels on one side of the vehicle, the function lane departure warning may achieve the objective of retaining the vehicle within a specific lane.

Thus a vehicle braking function relating to the function differential lock management may, based on the measure of instability S, request and potentially obtain an allocated braking action for application in at least one braking device configuration of the vehicle. By applying a braking action to a vehicle wheel or vehicle wheels in the vehicle suitable for the purpose, the function differential lock management may achieve the objective of connecting or disconnecting a differential lock in the vehicle's transmission.

Thus a vehicle braking function relating to the function brake control may, based on the measure of instability S, request and potentially obtain an allocated braking action for application in at least one braking device configuration of the vehicle. By applying the braking action to vehicle wheels on one side of the vehicle, the function's brake control may achieve the objective to control the vehicle's driving direction. This brake control is reminiscent to some extent of brake control in vehicles equipped with caterpillar treads.

Thus a vehicle braking function relating to the function incident compensation management, based on the measure of instability S, may request and potentially obtain an allocated braking action for application in at least one braking device configuration of the vehicle. By applying a braking action to the vehicle's wheels, for example only on one side of the vehicle, the function incident compensation management may achieve the objective to impact the vehicle's driving direction in the manner desired. One example of an incident may be that a hydraulic power steering hose in the vehicle is suffering from leakage. Thus a type of brake control is achieved, which to some extent is reminiscent of brake control in vehicles equipped with caterpillar treads.

The first control device 200 is arranged, based on a braking action request from a control device configuration, to establish whether the request may or may not be granted. The first control device 200 is arranged to establish whether only a part of the requested braking action may be granted. The first control device 200 is arranged to send a response signal to the control device configuration that sent the request, which response signal comprises information regarding a result of the establishing process relating to the request.

The first control device 200 is arranged to continuously establish a measure of instability S in relation to the vehicle 100. The first control device 200 is arranged to continuously establish the measure of instability S based on the signals S1, S2, S3 and S4, which signals are continuously provided to the first control device 200 through the first, second, third and fourth sensor configurations, respectively, as set out above. That measure of instability S is described in more detail with reference to FIG. 3 below.

The first control device 200 is arranged to continuously provide the measure of instability S within the internal communications network in the vehicle 100, to which network at least one vehicle braking function's control device is connected. Thus the first control device 200 is arranged to continuously send a signal SS to the third control device 230 via the link L230, which signal SS comprises information regarding the established measure of instability S. The third control device 230 is arranged to forward the signal SS to the link L240.

According to one embodiment, the first control device 200 is arranged to send the signal SS with a predetermined suitable frequency F. The frequency F may for example be 10 or 100 Hz. An updated measure of instability S may thus be provided to at least one of the control device configurations 240a-240d 10 or 100 times per second.

With reference to FIG. 2b, a device 298 in the vehicle 100 is shown. The device 298 may be arranged in the tractor 110.

A first braking device configuration 260a is arranged at a vehicle wheel (not displayed) in the vehicle. The braking device configuration 260a may comprise a manoeuvre element, also named an actuator, which is signal-connected with a link L260a to the third control device 230 and/or one or several of the control device configurations 240a, 240b, 240c and 240d. The first braking device configuration 260a may comprise a wheel brake of a suitable type. The first braking device configuration 260a may also, where appropriate, comprise equipment for pneumatic or hydraulic application of a braking action in the vehicle wheel.

In the same manner, each of a second braking device configuration 260b, third braking device configuration 260c and fourth braking device configuration 260d is arranged at a respective vehicle wheel. The braking device configurations 260b-260d may comprise a manoeuvre element, also named an actuator, which is signal connected to the third control device 230 and/or one or several of the control device configurations 240a, 240b, 240c and 240d with a link L260b, L260c and L260, respectively. It should be pointed out that the vehicle 100 may have a suitable number of braking device configurations arranged in order to brake a respective vehicle wheel. The braking device configurations 260a-260d may be controlled mutually independently with the first control device 200, the second control device 210, the third control device 230, and/or at least one of the control device configurations 240a-240d.

A fifth braking device configuration 270 is arranged in a transmission of the vehicle 100. The fifth braking device configuration 270 is according to one embodiment a so-called retarder. The fifth braking device configuration 270 may comprise a manoeuvre element, also named an actuator, which is signal-connected with a link L270 to the third control device 230 and/or one or several of the control device configurations 240a, 240b, 240c and 240d.

Vehicle braking functions stored in at least one of the control device configurations 240a-240d may thus be adapted to control braking action with a braking device in at least one vehicle wheel and/or the retarder 270, based on the established measure of instability S.

At least one of the first, second, third and fourth control device configurations 240a-240d may be adapted, where needed, to assess whether or not the vehicle braking function should be used, or alternatively changed, based on the measure of instability provided.

According to one example, where a control device configuration requests a certain measure of braking action in the retarder 270, but where, through the first control device 200, only a lower braking action is permitted for the retarder 270, the control device configuration may use the retarder 270 for braking to a limited extent, while other vehicle braking functions in the device may brake at least one vehicle wheel 260a-260d to achieve an appropriate braking action in the vehicle, based on the measure of instability S. Thus the initially requested vehicle braking function may change, according to one aspect of the invention.

FIG. 3 schematically illustrates a diagram according to one aspect of the present invention. In the diagram, a yaw rate Y (degrees/second) in the vehicle 100 is specified as a function of the time T (seconds).

A first graph F1 (sim) is illustrated in the diagram. The first graph F1 (sim) is a function which depends on the yaw rate Yawrate and the lateral acceleration Alat.

A second graph F2 (cal) is illustrated in the diagram. The second graph F2 (cal) is a function which depends on the vehicle speed V and the steering rate Steeringrate.

The first control device 200 may be adapted to continuously establish the measure of instability S based on a difference between an expected propulsion and an actual propulsion. The first control device 200 may be adapted to continuously establish/estimate/calculate/model the measure of instability S based on a difference between an expected propulsion and an actual propulsion.

The expected propulsion may be referred to as a first state. The actual propulsion may be referred to as a second state.

The expected propulsion may be established in an appropriate way. The actual propulsion may be established in an appropriate way.

The first control device 200 is adapted to continuously establish the expected propulsion by performing a simulation based on yaw rate Yawrate and lateral acceleration Alat.

The first control device 200 is adapted to continuously establish the actual propulsion by performing a calculation based on vehicle speed V and steering rate Steeringrate.

The first control device 200 comprises a stored vehicle model which continuously simulates values for the first graph F1 (sim). Thus a simulation is carried out with the stored vehicle model, based on values for the magnitudes yaw rate, Yawrate and lateral acceleration Alat, which values are continuously detected with the first sensor configuration 250a and the second sensor configuration 250b, respectively.

Thus a simulation is performed based on values for the magnitudes yaw rate Yawrate and lateral acceleration Alat. These values may continuously be detected by the first sensor configuration 250a respectively the second sensor configuration 250b.

Thus, a continuous estimation is established of how the vehicle 100 is expected to behave when the vehicle's wheels have adequate grip on the base and thus do not slip or slide. This state is also named an expected propulsion of the vehicle 100. Thus an expected propulsion of the vehicle 100 is established where all of the vehicle wheels have good grip on the road surface.

The first control device 200 is also arranged to continuously calculate values for the second graph F2 (cal). Thus a calculation is made based on values relating to the magnitudes of vehicle speed V and steering rate Steeringrate, which values are continuously detected with the third sensor configuration 250c and the fourth sensor configuration 250bd, respectively. Thus a calculation is performed based on values relating to the magnitudes of vehicle speed V and steering rate Steeringrate. Thus a measure is established continuously of how the vehicle 100 actually behaves during the prevailing propulsion. Thus prevailing conditions relating to the operation and the surrounding environment are taken into account. This state is also named the actual propulsion of the vehicle 100. Thus an actual propulsion of the vehicle 100 is established where all of the vehicle wheels according to one example do not necessarily have good grip on the road surface. According to one embodiment no simulation is hereby performed to continuously establish values for the second graph F2(cal).

According to one example embodiment of the present invention, the measure of instability S may be established based on a difference between the first graph F1(sim) and the second graph F2(cal). In other words, the measure of instability S may be established based on a difference between the expected propulsion and the actual propulsion.

The difference may continuously be established according to one embodiment. That difference may be established intermittently according to one embodiment.

According to one embodiment the graph F1(sim) may be connected with two boundary functions Th1 and Th2, which boundary functions relate to the respective boundaries of instability. If the measure of instability S indicates that F1 (sim) and F2 (cal) at a given point in time differ from each other in such a way that F2 (cal) is outside Th1 or Th2, the vehicle is deemed to be driven in an unstable condition. According to one definition, the measure of instability S may be provided as a percentage (%), where no difference between F1 (Sim) and F2 (cal) corresponds to 0%, and where a difference between F1 (Sim) and F2 (cal) which is consistent with Th1 or Th2 corresponds to 100%.

The first control device 200 may be arranged to establish if the vehicle is being driven in an unstable condition or not. The first control device 200 may be arranged to establish if the vehicle is being driven in an unstable condition or not based on the measure of instability S. The first control device 200 may be arranged to establish if the vehicle is being driven in an unstable condition or not based on the measure of instability S and the boundary functions Th1 and Th2. The first control device 200 may be arranged to establish if the vehicle is being driven in an unstable condition or not based on the measure of instability and at least one of the boundary functions Th1 and Th2. The first control device 200 may be arranged to establish if the vehicle is being driven in an unstable condition or not based on the difference and at least one of the boundary condition Th1 and Th2.

In FIG. 3 a measure of instability S(T1) is illustrated at a first point in time T1. At the first point in time T1, the measure of instability S(T1) is approximately

−50%. At the second point in time T2, the measure of instability S(T1) is approximately +75%.

According to one embodiment, the measure of instability S may be specified with a symbol. A symbol in the measure of instability may correlate to oversteer or understeer of the vehicle, having regard to in which direction (right or left) the vehicle is turning.

According to one embodiment the measure of instability S may be specified as an absolute amount and given a size.

It should be pointed out that the higher the absolute amount which the measure of instability S presents at a given point in time, the higher the risk of skidding or slipping in the vehicle 100.

The measure of instability S may be specified continuously or in discrete steps, for example in steps of 5% or 10%.

According to one embodiment the measure of instability S may be established based on at least one of the parameters of vehicle speed V, lateral acceleration Alat of the vehicle, yaw rate Yawrate, steering angle Steeringangle, steering rate Steeringrate and wheel slip Slip in at least one of the vehicle's wheels 260a-260d. Thus there are elements (not shown) to continuously establish wheel slip in the vehicle's wheels 260a-260d. According to one embodiment, the first control device 200 is arranged through suitable equipment to continuously establish wheel slip Slip in at least one of the vehicle's wheels 260a-260d.

According to one embodiment the measure of instability S may be established based on a combination of two or more parameters: vehicle speed V, lateral acceleration Alat of the vehicle, yaw rate Yawrate, steering angle Steeringangle, steering rate Steeringrate and wheel slip Slip in at least one of the vehicle's wheels 260a-260d.

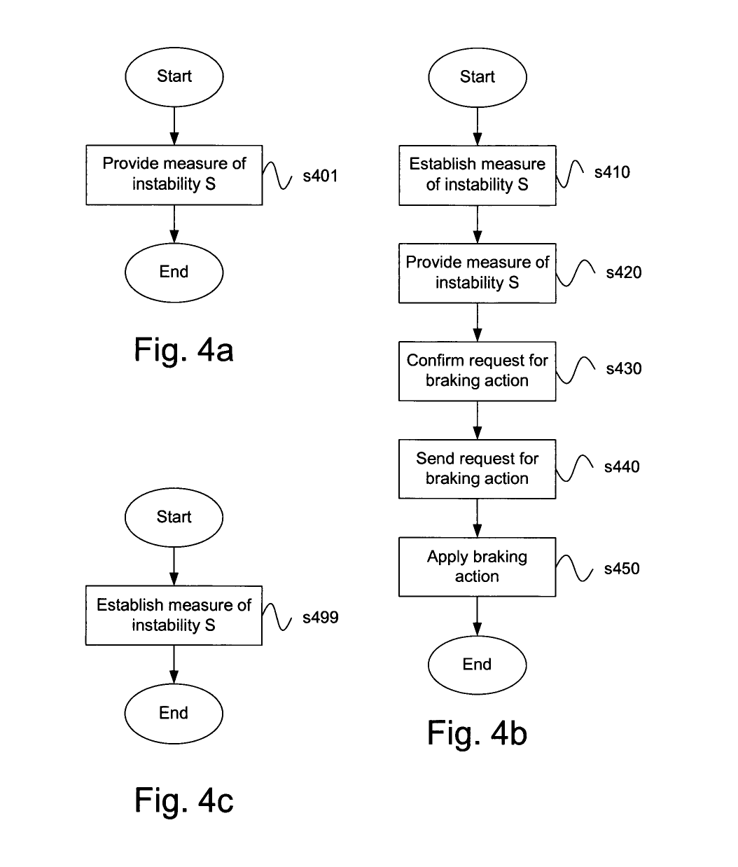

FIG. 4a schematically illustrates a flow diagram of a method for the improvement of safety when driving a vehicle, according to one embodiment of the invention.

The method comprises a first method step s401. The step s401 comprises the steps to:
continuously establish a measure of instability relating to the vehicle; and
continuously provide the measure of instability within a communications network internal to the vehicle, to which network at least one vehicle braking function's control device is connected. The method is completed after step s401.

FIG. 4b schematically illustrates a flow diagram of a method for the improvement of safety when driving a vehicle, according to one embodiment of the invention.

The method comprises an initial method step of the procedure s410. The method step s410 comprises the step to continuously establish a measure of instability S in relation to the vehicle 100. The measure of instability may be established in a suitable manner, for example as described with reference to FIG. 3 above.

According to one example the method step s410 may comprise the step to continuously establish the measure of instability S, based on at least one or a combination of the parameters vehicle speed V, lateral acceleration Alat of the vehicle, yaw rate Yawrate, steering angle Steeringangle, steering rate Steeringrate and wheel slip Slip in at least one of the vehicle's wheels 260a-260d.

The method step s410 may comprise the step to continuously establish the measure of instability S, based on a difference between an expected propulsion and an actual propulsion. This can be performed by means of the first control device 200.

The method step s410 may comprise the step to continuously establish the expected propulsion by performing a simulation based on yaw rate Yawrate and lateral acceleration Alat. This can be performed by means of the first control device 200.

The method step s410 may comprise the step to continuously establish the actual propulsion by performing a calculation based on vehicle speed V and steering rate Steeringrate. This can be performed by means of the first control device 200.

Following the method step s410, a subsequent method step s420 is completed.

The method step s420 comprises the step to continuously provide the measure of instability S within a communications network internal to the vehicle, to which network at least one vehicle braking function's control device configuration is connected. The communications network may comprise the links L230 and L240. Following the method step s420, a subsequent method step s430 is completed.

The method step s430 comprises the step to establish a request for braking action in at least one braking device configuration 260a-260d and/or a braking device configuration 270. The method step s430 may comprise the step to, where needed, determine whether or not the vehicle braking function should be used, based on the measure of instability S provided. The method step s430 may comprise the step to, through the control device configuration, adapt the use of the vehicle's braking function to needs, as well as to the measure of instability S. The method step s430 may comprise the step to, based on the measure of instability, prioritise the use of at least one vehicle braking function of a number of available vehicle braking functions.

The request for braking action in at least one braking device configuration 260a-260d and/or braking device configuration 270 may comprise information regarding a size and duration configuration in relation to the requested braking action. Following the method step s430, a subsequent method step s440 is completed.

The method step s440 comprises the step to send an established request for braking action from the control device to the first control device 200, the second control device 210 or the third control device 230. Following the method step s440, a subsequent method step s450 is completed.

The method step s450 comprises the step to, where appropriate, apply the requested braking action in at least one braking device configuration 260a-260d and/or the braking device configuration 270. The method step s450 also comprises the steps to establish whether the request may be granted and to send a response to the requesting control device configuration. The response may comprise information regarding whether or not the request is granted, alternatively that the request is granted with certain restrictions, for example that only 50% or 75% of the requested braking action may be granted. In the event the request is granted with certain restrictions, the requesting control device configuration may establish whether or not a limited braking action should be applied. The establishing process may occur based on responses made and/or measures of instability specified. Following the method step s450, the method is completed.

FIG. 4c schematically illustrates a flow diagram of a method for the improvement of safety when driving a vehicle, according to one embodiment of the invention.

The method comprises a first method step s499. The method step s499 comprises the steps to:
continuously establish a measure of instability with respect to the vehicle;
continuously provide the measure of instability within a communications network internal to the vehicle to which network at least one vehicle braking functions' control device is connected; and
continuously establish the measure of instability based on a difference between an expected propulsion and an actual propulsion.

After the step s499 the method is ended.

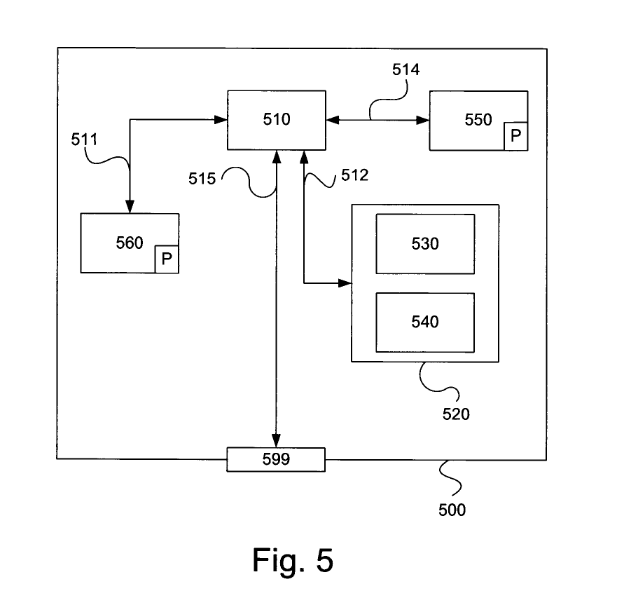

With reference to FIG. 5, a diagram of an embodiment of system 500 is shown. The control units 200, 210 and 230, which are described with reference to FIG. 2a and FIG. 2b may in one embodiment comprise the system 500. The control device configurations 240a, 240b, 240c and 240d which are described with reference to FIG. 2a and FIG. 2b may in one embodiment comprise the system 500. The unit 500 includes a non-volatile memory 520, a data processing unit 510 and a read/write memory 550. The non-volatile memory 520 has a first memory part 530 wherein a computer program, such as an operative system, is stored to control the function of the unit 500. Further, the unit 500 includes a bus controller, a serial communications port, an I/O device, an ND converter, a date-time input and transmission unit, an event counter and an interrupt controller (not displayed). The non-volatile memory 520 also has a second memory part 540.

Thus a computer program P is provided comprising procedures for the improvement of safety when driving a vehicle 100, according to the innovative method.

The computer program P may comprise procedures to continuously establish the measure of instability based on a difference between an expected propulsion and an actual propulsion. The computer program P may comprise procedures to continuously establish the expected propulsion by performing a simulation based on yaw rate Yawrate and lateral acceleration Alat.

The computer program P may comprise procedures to continuously establish the actual propulsion by performing a calculation based on vehicle speed V and steering rate Steeringrate.

The computer program P may comprise procedures to continuously establish a measure of instability S in relation to the vehicle 100. The computer program P may comprise routines to continuously provide the measure of instability S within a communications network internal to the vehicle, which network may comprise the links L230 and L240, to which network at least one vehicle braking function's control device is connected. The computer program P may comprise procedures to, where needed, determine whether or not the vehicle braking function should be used based on the measure of instability S provided. The computer program P may comprise procedures to adapt the use of the vehicle's braking function to need, as well as to the measure of instability S. The computer program P may comprise procedures, based on the measure of instability S, to prioritise the use of at least one vehicle braking function of a number of available vehicle braking functions. The computer program P may comprise routines to control braking of at least one vehicle wheel 260a-260d and/or braking of a so-called retarder 270 in the vehicle, based on the measure of instability S. The computer program P may comprise procedures to request a braking action for at least one vehicle wheel 260a-260d and/or braking of a so-called retarder 270 in the vehicle 100 based on the measure of instability S. The computer program P may comprise procedures to request a braking action for the vehicle braking function in relation to at least one out of the group comprising lane departure warning, differential lock management, brake control and incident compensation management. The computer program P may comprise procedures to continuously establish the measure of instability S based on at least the parameters of lateral acceleration Alat in the vehicle and yaw rate Yawrate on the one hand, and vehicle speed V and steering rate Steeringrate on the other hand. The computer program P may comprise procedures to continuously establish the measure of instability S, based on at least one or a combination of the parameters of vehicle speed V, lateral acceleration Alat of the vehicle, yaw rate Yawrate, steering angle Steeringangle, steering rate Steeringrate and wheel slip Slip in at least one of the vehicle's wheels 260a-260d. The computer program P may comprise procedures to continuously provide the measure of instability S via the communications network internal to the vehicle, to a central control device 230, also named a controller.

The program P may be stored in an executable manner or in a compressed manner in a memory 560 and/or a read/write memory 550.

A statement that the data processing unit 510 performs a certain function means that the data processing unit 510 performs a certain part of the program which is stored in the memory 560 or a certain part of the program stored in the read/write memory 550.

The data processing unit 510 may communicate with a data port 599 via a data bus 515. The non-volatile memory 520 is intended for communication with the data processing unit 510 via a data bus 512. The separate memory 560 is intended for communication with the data processing unit 510 via a data bus 511. The read/write memory 550 is arranged to communicate with the data processing unit 510 via a data bus 514. The links L210, L230, L240, L250a-L250d, L260a-L260d and L270, may be connected to the data port 599 (see FIG. 2a and FIG. 2b).

When data is received in the data port 599, it is temporarily stored in the second memory part 540. When in-data received is temporarily stored, the data processing unit 510 is ready to carry out execution of code in the manner described above. According to one embodiment, signals, e.g. S1, S2, S3 and S4, received in the data port 599, comprise information regarding lateral acceleration Alat in the vehicle, yaw rate Yawrate, vehicle speed V and steering rate Steeringrate, respectively. According to one embodiment, signals received in the data port 599 comprise information regarding the established measure of instability S. The signals received in the data port 599 may be used by the system 500 to continuously provide the measure of instability S within a communications network internal to the vehicle, to which network at least one vehicle braking function's control device is connected.

Parts of the methods described herein may be carried out by the unit 500 with the help of the data processing unit 510, which runs the program stored in the memory 560 or the read/write memory 550. When the unit 500 runs the program, the procedures described herein are executed.

The foregoing description of the preferred embodiments of the present invention has been furnished for illustrative and descriptive purposes. It is not intended to be exhaustive, or to limit the invention to the variants described. Many modifications and variations will obviously be apparent to one skilled in the art. The embodiments have been chosen and described in order to best explicate the principles of the invention and its practical applications, and to thereby enable one skilled in the art to understand the invention in terms of its various embodiments and with the various modifications that are applicable to its intended use.

1. A method for improvement of the safety of a vehicle being driven comprising the steps of:
continuously establishing a measure of instability of the vehicle;
continuously providing the measure of instability within a communications network internal to the vehicle, while connecting the network to at least one vehicle braking function control device;
wherein the establishment of the measure of instability is based on a difference between an expected propulsion and an actual propulsion.

2. A method according to claim 1, further comprising the step of:
continuously establishing the expected propulsion by performing a simulation based on yaw rate (Yawrate) and lateral acceleration (Alat).

3. A method according to claim 1, comprising the step of:
continuously establishing the actual propulsion by performing a calculation based on vehicle speed (V) and steering rate (Steering rate).

4. A method according to claim 1, further comprising the step of:
using a control device to assess whether or not the vehicle braking function should be used based on the measure of instability provided.

5. A method according to claim 4, comprising the step of:
using the control device to adjust the use of the vehicle braking function based on need and to the measure of instability.

6. A method according to claim 1, further comprising the step of:
based on the measure of instability, at least one of prioritizing the use of at least one vehicle braking function of a number of available vehicle braking functions and changing the distribution of braking action among different vehicle braking functions.

7. A method according to claim 1, wherein the vehicle braking function comprises at least one of braking of at least one vehicle wheel and braking of a so-called retarder in the vehicle.

8. A method according to claim 1, wherein the communications network comprises a CAN-bus.

9. A method according to claim 1, wherein the vehicle braking function is one out of a group comprising a lane departure warning, a differential lock management, a brake control, and an incident compensation management.

10. A method according to claim 1, further comprising the step of:
continuously establishing the measure of instability, based on at least one or a combination of a parameter comprising vehicle speed, lateral acceleration of the vehicle, yaw rate, steering angle, steering rate and wheel slip in at least one of the vehicle wheels.

11. A method according to claim 1, further comprising the step of:
continuously providing the measure of instability to a central control device, also named a controller, via the communications network internal to the vehicle.

12. A device for the improvement of safety when driving a vehicle comprising:
elements configured to continuously establish a measure of instability of the vehicle when driven;
a communications network internal to the vehicle elements configured to continuously provide the measure of instability within the communications network;
at least one vehicle braking function control device connected to the communications network; and
further elements configured to continuously establish the measure of instability based on a difference between an expected propulsion and an actual propulsion.

13. A device according to claim 12, further comprising:
further elements configured to continuously establish the expected propulsion by performing a simulation based on yaw rate (Yawrate) and lateral acceleration (Alat).

14. A device according to claim 12, further comprising:
further elements configured to continuously establish the actual propulsion by performing a calculation based on vehicle speed (V) and steering rate (Steering rate).

15. A device according to claim 12, further comprising a control device is configured to assess whether or not the vehicle braking function should be used based on the measure of instability provided.

16. A device according to claim 12, wherein the control device is configured to adjust the use of the vehicle braking function to a need for the braking function, in addition to the measure of instability.

17. A device according to claim 12, further comprising:
further elements configured, based on the measure of instability, to at least one of prioritise use of at least one vehicle braking function of a number of available vehicle braking functions and to change distribution of braking action among different vehicle braking functions.

18. A device according to claim 12, wherein the vehicle braking function comprises at least one of braking of at least one vehicle wheel and braking of a so-called retarder in the vehicle.

19. A device according to claim 12, wherein the communications network comprises a CAN-bus.

20. A device according to claim 12, wherein the vehicle braking function is one of a group comprising a lane departure warning, a differential lock management, a steering brake, and an incident compensation management.

21. A device according to claim 12, further comprising:
further elements configured to continuously establish the measure of instability, based on at least one or a combination of parameters of vehicle speed, lateral acceleration of the vehicle, yaw rate, steering angle, steering rate and wheel slip in at least one of the vehicle's wheels.

22. A device according to claim 12, further comprising:
further elements configured to continuously provide the measure of instability to a central control device, also named a controller, via the communications network internal to the vehicle.

23. A vehicle comprising a device according to claim 12.

24. A motor vehicle according to claim 23, wherein the vehicle is a truck, a bus or a car.

25. (canceled)

26. A computer program product for improvement of safety when driving a vehicle, comprising a computer program comprising computer program code stored in a non-transitory computer-readable medium, the program code causing an electronic control device, or another computer connected to the electronic control device to perform the steps according to claim 1, when the computer program is run in an electronic control device, or in another computer connected to the electronic control device.
